(19) United States
(12) Patent Application Publication
(10) Pub. No.: US 2014/0045008 A1
(43) Pub. Date: Feb. 13, 2014

(54) LARGE FORMAT LITHIUM-ION BATTERY CELL WITH IMPROVED SAFTEY AGAINST CRUSH AND PUNCTURE

(71) Applicants: Wuzhao YAN, Dongguan (CN); Peng WANG, Dongguan (CN); Jing JIN, Dongguan (CN); Kai LI, Dongguan (CN); Wanhao YAO, Dongguan (CN); Zhijun GUO, Dongguan (CN)

(72) Inventors: Wuzhao YAN, Dongguan (CN); Peng WANG, Dongguan (CN); Jing JIN, Dongguan (CN); Kai LI, Dongguan (CN); Wanhao YAO, Dongguan (CN); Zhijun GUO, Dongguan (CN)

(21) Appl. No.: 13/654,875

(22) Filed: Oct. 18, 2012

(30) Foreign Application Priority Data
Aug. 10, 2012 (CN) 201210282855.9

(51) Int. Cl. H01M 10/42; H01M 2/36; H01M 2/12

(52) U.S. Cl. 429/89

(57) ABSTRACT

The invention relates to a lithium-ion battery cell, which comprises an electrode component, a metal can for accommodating the electrode component, electrolyte injected into the metal can, and a cap plate affixed to the metal can, wherein the electrode component comprises a cathode film, an anode film and separator; a cathode tab is arranged on the positive plate; an anode tab is arranged on the negative plate; the cap plate is provided with a positive terminal electrically connected with the cathode tab, a negative terminal electrically connected with the anode tab, a liquid injection hole and an explosion-proof vent; safety components are assembled between the metal can and the electrode component and electrically connected with the positive terminal or the negative terminal; and the metal can is electrically connected with the negative terminal or the positive terminal.

### FIELD OF THE INVENTION

The invention belongs to the field of large format lithium-ion battery cells, in particular relates to a lithium-ion battery cell equipped with safety components against crush and puncture.

### BACKGROUND OF THE INVENTION

With the development of the modern society and the reinforcement of the environmental awareness, more and more devices adopt rechargeable cells as battery sources, for example, laptops, smart phones, MP3, electric vehicles (EV) and energy storage systems (ESS). EV and ESS applications have high demand on the capacity of each single cell. On the other hand, the safety of the cells in such systems is crucial and must be ensured under severe conditions. In terms of cell format, prismatic can is getting more attention, due to its hardness and strength, resulting in better impact resistance throughout the lifetime of EV and ESS.

Various abuse tests have been developed to test the safety performance of lithium-ion battery cells in extreme circumstances, among which, two of the most extreme abuses include puncture and crush. These two tests are implemented to simulate the damage to the battery in the event of a car accident. During such events, the temperature inside the cells will rise and pose a potential risk of thermal runaway.

Aims of embodiments of the present invention are to enhance the crush and puncture endurance of a lithium-ion battery cell.

As illustrated in FIG. 1, a lithium-ion battery cell generally consists of an electrode component 1, a metal can 2 for accommodating the electrode component 1, electrolyte injected into the metal can 2, and a cap plate 3 affixed to the metal can 2. The electrode component 1 consists of a cathode film, an anode film and separator between them; an anode tab 11 is connected to the anode film; a cathode tab 12 is connected to the cathode film. The cap plate 3 is made up of a positive terminal 31 electrically connected with the anode tab 11, a negative terminal 32 electrically connected with the cathode tab 12, a liquid injection hole 33 and a safety vent 34.

In order to improve the safety performance of the lithium-ion battery cell, one earlier US patent (Application No. US20100279170) discloses two short-circuit units, wherein the short-circuit units are metal foils or metal plates wound on the periphery of an electrode component. While the safety performance of the cells can be improved to a certain degree, the metal foils or the metal plates of the two short-circuit units are wound outside the electrode component, they are not enough for such a huge current during the abuse test; the short-circuit units do not use cans, leading to a energy density loss of the cell.

Regarding of this, it is necessary to provide a lithium-ion battery cell, wherein the energy density can be improved and the lithium-ion battery cell is easy to be manufactured and has high safety performance.

### SUMMARY OF THE INVENTION

The purpose of the invention is to overcome the defects of the prior art and provide a lithium-ion battery cell with enhanced crush and puncture endurance of a lithium-ion battery cell, whose energy density can be improved and the lithium-ion battery cell is easy to process.

The invention relates to a lithium-ion battery cell, which comprises an electrode component, a metal can for accommodating the electrode component, electrolyte injected into the metal can, and a cap plate affixed to the metal can, wherein the electrode component comprises a cathode film, an anode film and separator between them; a cathode tab is arranged on the anode film; an anode tab is arranged on the cathode film; the cap plate is made up of a positive terminal electrically connected with the cathode tab, a negative terminal electrically connected with the anode tab, a liquid injection hole and an explosion-proof vent; safety components are assembled between the metal can and the electrode component and electrically connected with the positive terminal or the negative terminal; and the metal can is electrically connected with the negative terminal or the positive terminal, respectively. The battery is designed to short circuit the cathode and anode when the battery is punctured and crushed through electrically connecting the metal can and the safety components.

Wherein, the metal can is made of stainless steel or aluminum; the electrode component can be a jellyroll wound by the cathode film, the anode film and the separator, or laminated by the above, or a mixture of windings and laminations.

The lithium-ion battery cell in this invention contains the safety components. When the cell is subjected to external severe damage, the safety components and the metal can are electrically connected with two electrodes of the electrode component respectively. The conversion of possible internal short circuit into external short circuit is realized, thus the current density inside the battery cell is reduced; a series of reactions caused by the overheating of a system in the cell are avoided; and the safety performance of the lithium-ion battery cell is guaranteed.

As an improvement of the lithium-ion battery cell provided by the invention, the safety components are metal plates.

As an improvement of the lithium-ion battery cell provided by the invention, the metal plates are aluminum plates, copper plates, steel plates or nickel plates.

As an improvement of the lithium-ion battery cell provided by the invention, the thickness of the metal plates is between 0.005 mm and 2.0 mm. If the metal plates are too thin, the current tolerance may be poor. If the metal plates are too thick, the energy density of the cell may be affected.

As an improvement of the lithium-ion battery cell provided by the invention, the thickness of the metal plates is between 0.1 mm and 0.3 mm.

As an improvement of the lithium-ion battery cell provided by the invention, the length of the safety components is less than or equal to that of broadwise of the electrode component and the width of the safety components is less than or equal to that of the broadwise of the electrode component.

As an improvement of the lithium-ion battery cell provided by the invention, an insulating film is arranged between each metal plate and the metal can to prevent the short circuit between the metal plates and the metal can during the normal use of the cell.

As an improvement of the lithium-ion battery cell provided by the invention, the insulating films are made of polypropylene (PP), polyethylene terephthalate (PET) or polyethylene (PE).

As an improvement of the lithium-ion battery cell provided by the invention, the thickness of the insulating films is between 1 micrometer and 1000 micrometers.

As an improvement of the lithium-ion battery cell provided by the invention, each safety component is provided with a tab which is electrically connected with the anode tab or the cathode tab respectively; the tabs of the safety components are electrically connected with the anode tab or the cathode tab; and the metal can is electrically connected with the cathode tab or the anode tab.

Compared with the prior art, the lithium-ion battery cell in the invention at least has the advantages that:

The lithium-ion battery cell provided by the invention has good safety performance. When the cell is subjected to nail puncture or crush, the current can be discharged through the metal can and the metal plates, so that the cell temperature may not rise too high, thus the good safety of the cell is guaranteed. Moreover, the metal can of the cell provided by the invention may also be part of the safety components, a part of space can be saved for the electrode component, and thus the energy density of the cell can be improved. Besides, the metal plates assembled on the surfaces of the electrode component is much stronger than that wound on the surfaces of the electrode component, thus the process of the cell provided by the invention is simpler.

### BRIEF DESCRIPTION OF THE DRAWINGS

Detailed description of the lithium-ion battery cell in this invention and the advantages thereof with the attached drawings and the preferred embodiments are given below, wherein

FIG. 1 is a section view of a lithium-ion battery cell in the prior art;

FIG. 2 is a stereogram of the lithium-ion battery cell provided by the invention;

FIG. 3 is a front perspective view of the lithium-ion battery cell provided by the invention;

FIG. 4 is a structure diagram of the electrode component and the safety components of the lithium-ion battery cell provided by the invention; and

FIG. 5 is a side section view of the lithium-ion battery cell provided by the invention.

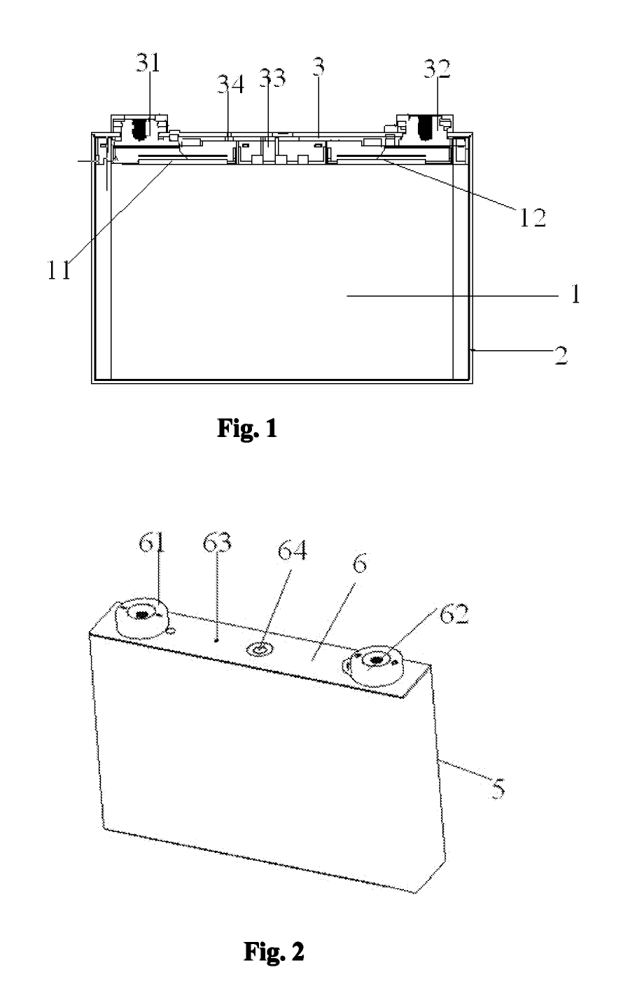

### DETAILED DESCRIPTION OF THE PREFERRED EMBODIMENTS

Detailed description of the lithium-ion battery cell in this invention and the advantages thereof with the attached drawings and the preferred embodiments are listed below, but this invention is not limit to these embodiments illustrated herein.

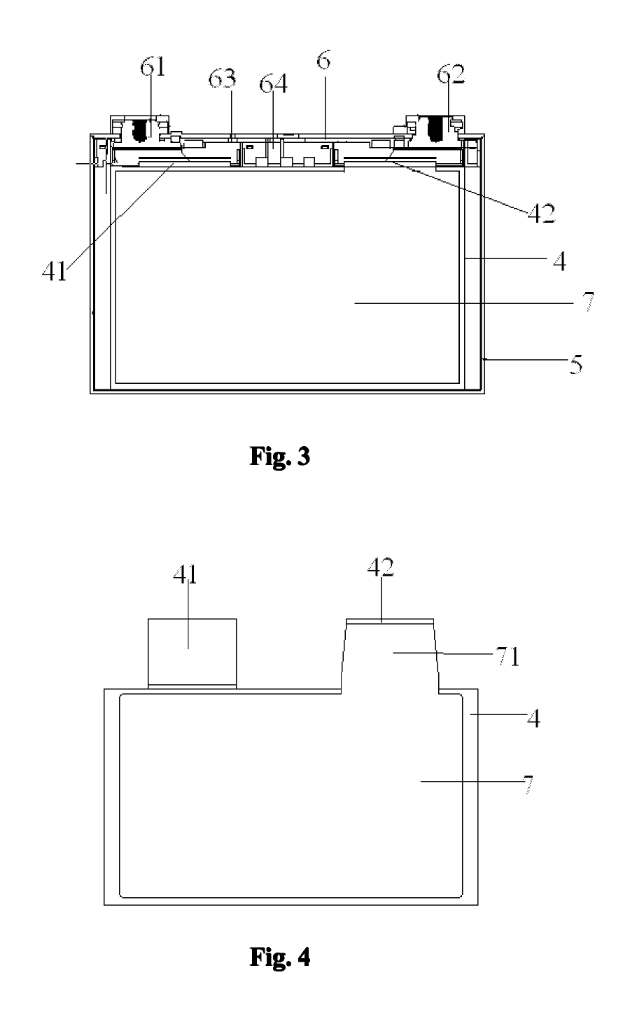

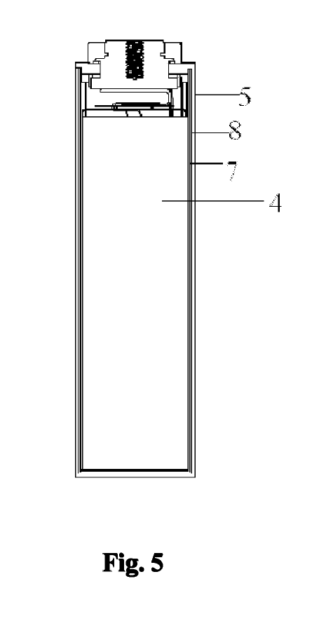

As illustrated in FIGS. 2 to 5, the lithium-ion battery cell provided by the invention comprises an electrode component 4, a metal can 5 for accommodating the electrode component 4, electrolyte injected into the metal can 5, and a cap plate 6 affixed to the metal can 5, wherein the electrode component 4 comprises a cathode film, an anode film and separator spaced between them; an cathode tab 41 is arranged on the cathode film; an anode tab 42 is arranged on the anode film; tabs mentioned here are uncoated area of the cathode and anode films; the cap plate 6 consists of a positive terminal 61 electrically connected with the cathode tab 41, a negative terminal 62 electrically connected with the anode tab 42, a liquid injection hole 63 and an explosion-proof vent 64; safety components 7 are assembled between the metal can 5 and the electrode component 4 and electrically connected with the positive terminal 61 or the negative terminal 62, safety components 7 cover around the electrode component 4, the metal can 5 is electrically connected with the negative terminal 62 or the positive terminal 61, respectively. The can have a polarity, negative or positive.

Wherein, the safety components 7 are metal plates.

The metal plates are aluminum plates, copper plates, steel plates or nickel plates.

The thickness of the metal plates is between 0.005 mm and 2.0 mm.

The thickness of the metal plates is between 0.1 mm and 0.3 mm.

The length of the safety components 7 is less than or equal to that of broadwise of the electrode component 4 and the width of the safety components 7 is less than or equal to that of the broadwise of the electrode component 4.

An insulating film 8 is arranged between each metal plate and the metal can.

The insulating films 8 are made of polypropylene (PP), polyethylene terephthalate (PET) or polyethylene (PE).

The thickness of the insulating films 8 is between 1 micrometer and 1000 micrometers.

Each safety component 7 is provided with a tab which is electrically connected with the cathode tab 41 or the anode tab 42.

The safety components 7 are electrically connected with the cathode tab 41 or the anode tab 42 while the metal can 5 is electrically connected with the anode tab 42 or the cathode tab 41.

The electrode component 4 in the lithium-ion battery cell can be a jellyroll wound by or laminated with a cathode film, an anode film and separator, and can also be a mixture of winding and lamination.

Specifically, the connection relations of the lithium-ion battery cell can be described as below:

The cap plate 6 is arranged on the upper part of the metal can 5 and affixed with the metal can 5 by laser welding. The cap plate 6 is electrically connected with the positive terminal 61 or the negative terminal 62 by riveting or soldering, or is subjected to injection molding with the positive terminal 61 or the negative terminal 62.

Part of the top of cathode of the electrode component 4 is uncoated aluminum foil, named the cathode tab. The cathode tab 41 is electrically connected with the positive terminal 61 through a transferring plate of the cathode (or is directly welded on the positive terminal), wherein the cathode tab 41 can be electrically connected with the transferring plate of the cathode by laser welding or ultrasonic welding; and the transferring plate can be electrically connected with the positive terminal 61 by laser welding.

Part of the top of an anode of the electrode component 4 is uncoated copper foil, named anode tab 42. The anode tab 42 is electrically connected with the negative terminal 62 by flexible connection (or is directly welded on the negative terminal), wherein the anode tab 42 can be electrically connected with a transferring plate of the anode by laser welding or ultrasonic welding; and the transferring plate can be electrically connected with the negative terminal 62 by laser welding.

The metal can 5 is electrically connected with the cathode tab 41 by laser welding or ultrasonic welding; the electrode component 4 has two wide side faces and two narrow side faces; the safety components 7 are arranged on the two wide side faces of the electrode component 4 respectively; the safety components 7 are electrically connected with the anode tab 42 of the electrode component 4 and are metal plates in the shape of rectangle or others; the length and the width of the metal plates are less than or equal to those of the electrode component 4; a trapezoidal structure of which the shape is close to that of the anode tab 42 is arranged at one side of the upper part of each metal plate; the trapezoidal structures are tabs 71 of the metal plates; and the tabs of the metal plates are superposed on the anode tab 42 and electrically connected with the transferring plate by ultrasonic welding or laser welding (as illustrated in FIG. 4).

Moreover, the insulating films 8 are arranged between the metal plates and the metal can 5 to prevent the short circuit between the metal plates and the metal can 5 during the normal use of the cell.

### Embodiment 1

Preparation of a positive plate: taking 90% (in percentage by weight, compared to the weight of powder, similarly hereafter) LiNi_{1/3}Co_{1/3}Mn_{1/3}O₂ as an active material of an anode, 5% polyvinylidene fluoride (PVDF) as a binder, and 5% carbon black as a conductive agent; adding the above materials into N-methylpyrrolidine (NMP) for uniform stirring to prepare anode slurry; uniformly coating the slurry to an aluminum foil as a current collector for the cathode; drying, calendering and cutting the obtained product; and welding a cathode tab to prepare the positive film.

Preparation of a negative plate: taking 95% artificial graphite as an active material of a cathode, 2.5% styrene butadiene rubber (SBR) as a binder, and 2.5% carboxymethyl cellulose (CMC) as a thickener; adding the above materials into deionized water for uniform stirring to prepare cathode slurry; uniformly coating the anode slurry to a copper foil as a current collector for the anode; drying, calender and cutting the obtained product; and welding an anode tab to prepare the negative film.

Preparation of separator: taking a polyethylene microporous membrane as the separator.

Preparation of electrolyte: taking lithium hexafluorophosphate (LiPF₆) with the concentration of 1.0M as lithium and a mixture of propene carbonate (PC), ethylene carbonate (EC) and dimethyl carbonate (DMC) as a solvent, wherein the weight ratio of the propene carbonate to the ethylene carbonate to the dimethyl carbonate is PC:EC:DMC=1:1:1; and adding 1 wt % electrolyte additive vinylene carbonate (VC).

Preparation of an electrode component 4: preparing the electrode component 4 by winding or lamination of the above items, wherein a one-layer to four-layer diaphragm is arranged outside the electrode plates.

Preparation of a lithium-ion battery cell: allowing the cathode tab 41 of the prepared electrode component 4 to be connected with a positive terminal 61 on a cap plate 6 by laser welding; allowing the negative plate, the positive plate and the separator prepared by the above processes to be overlapped in turn and subjected to welded connection by winding; allowing the anode tab 42 to be connected with a negative terminal 62 on the cap plate 6 by laser welding, wherein the positive terminal 61 is electrically connected with a metal can 5, and an insulating disc is arranged between the negative terminal 62 and the metal can 5 to realize electrical insulation; arranging copper plates with the thickness of 0.2 mm on two larger surfaces of the electrode component 4 respectively; allowing the copper plates to be connected with the negative terminal 62 by laser welding; applying one layer of insulating film 8 on the surface of each copper plate, wherein the insulating film 8 has the thickness of 10 micrometers, is made of polypropylene (PP), and completely covers the copper plate; placing the electrode component 4 and the cap plate 6 into the metal can 5 (the metal can in the embodiment is an aluminum can) together with the copper plates; allowing the aluminum can to be connected with the cap plate 6 by laser welding; injecting the electrolyte into the aluminum can; and preparing the lithium-ion battery cell by the processes such as formation.

### Embodiment 2

The differences of the embodiment with the embodiment 1 are as follows:

Preparation of a lithium-ion battery cell: allowing the cathode tab 41 of the prepared electrode component 4 to be connected with a positive terminal 61 on a cap plate 6 by ultrasonic welding and the anode tab 42 to be connected with a negative terminal 62 on the cap plate 6 by ultrasonic welding, wherein an insulating disc is arranged between the positive terminal 61 and a metal can 5 to realize electrical insulation, and the negative terminal 62 is electrically connected with the metal can 5; arranging aluminum plates with the thickness of 0.3 mm on two larger surfaces of the electrode component 4 respectively; allowing the aluminum plates to be connected with the positive terminal 61 by ultrasonic welding; applying one layer of insulating film 8 on the surface of each aluminum plate, wherein the insulating film 8 is made of polypropylene (PP), has the thickness of 100 micrometers, and completely covers the aluminum plate; placing the electrode component 4 and the cap plate 6 into the metal can 5 (the metal can in the embodiment is a stainless steel can) together with the aluminum plates; allowing the stainless steel can to be connected with the cap plate 6 by laser welding; injecting the electrolyte into the stainless steel can; and preparing the lithium-ion battery cell by the processes such as formation.

Others are the same with those of the embodiment 1 and not described in detail herein.

### Embodiment 3

The differences of the embodiment with the embodiment 1 are as follows:

Preparation of a lithium-ion battery cell: allowing the cathode tab 41 of the prepared electrode component 4 to be connected with a positive terminal 61 on a cap plate 6 by laser welding and the anode tab 42 to be connected with a negative terminal 62 on the cap plate 6 by laser welding, wherein the positive terminal 61 is electrically connected with a metal can 5, and an insulating disc is arranged between the negative terminal 62 and the metal can to realize electrical insulation; arranging nickel plates with the thickness of 1.5 mm on two larger surfaces of the electrode component 4 respectively; allowing the nickel plates to be connected with the negative terminal 62 by laser welding; applying one layer of insulating film 8 on the surface of each nickel plate, wherein the insulating film 8 has the thickness of 500 micrometers, is made of polyethylene terephthalate (PET), and completely covers the nickel plate; placing the electrode component 4 and the cap plate 6 into the metal can (the metal can in the embodiment is an aluminum can) together with the nickel plates; allowing the aluminum can to be connected with the cap plate 6 by laser welding; injecting the electrolyte into the aluminum can; and preparing the lithium-ion battery cell by the processes such as formation.

Others are the same with those of the embodiment 1 and not described in detail herein.

### Embodiment 4

The differences of the embodiment with the embodiment 1 are as follows:

Preparation of a lithium-ion battery cell: allowing the cathode tab 41 of the prepared electrode component 4 to be connected with a positive terminal 61 on a cap plate 6 by ultrasonic welding and the anode tab 42 to be connected with a negative terminal 62 on the cap plate 6 by ultrasonic welding, wherein an insulating disc is arranged between the positive terminal 61 and a metal can 5 to realize electrical insulation, and the negative terminal 62 is electrically connected with the metal can 5; arranging aluminum plates with the thickness of 0.05 mm on two larger surfaces of the electrode component 4 respectively; allowing the aluminum plates to be connected with the positive terminal 61 by ultrasonic welding; applying one layer of insulating film 8 on the surface of each aluminum plate, wherein the insulating film 8 is made of polyethylene terephthalate (PET), has the thickness of 1 micrometer, and completely covers the aluminum plate; placing the electrode component 4 and the cap plate 6 into the metal can 5 (the metal can in the embodiment is a stainless steel can) together with the aluminum plates; allowing the stainless steel can to be connected with the cap plate 6 by riveting; injecting the electrolyte into the stainless steel can; and preparing the lithium-ion battery cell by the processes such as formation.

Others are the same with those of the embodiment 1 and not described in detail herein.

### Embodiment 5

The differences of the embodiment with the embodiment 1 are as follows:

Preparation of a lithium-ion battery cell: allowing the cathode tab 41 of the prepared electrode component 4 to be connected with a positive terminal 61 on a cap plate 6 by ultrasonic welding and the anode tab 42 to be connected with a negative terminal 62 on the cap plate 6 by ultrasonic welding, wherein the positive terminal 61 is electrically connected with a metal can 5, and an insulating disc is arranged between the negative terminal 62 and the metal can 5 to realize electrical insulation; arranging nickel plates with the thickness of 1 mm on two larger surfaces of the electrode component 4 respectively; allowing the nickel plates to be connected with the negative terminal 62 by ultrasonic welding; applying one layer of insulating film 8 on the surface of each nickel plate, wherein the insulating film 8 has the thickness of 900 micrometers, is made of polypropylene (PP), and completely covers the nickel plate; placing the electrode component 4 and the cap plate 6 into the metal can 5 (the metal can in the embodiment is a stainless steel can) together with the nickel plates; allowing the stainless steel can to be connected with the cap plate 6 by laser welding; injecting the electrolyte into the stainless steel can; and preparing the lithium-ion battery cell by the processes such as formation.

Others are the same with those of the embodiment 1 and not described in detail herein.

### Embodiment 6

The differences of the embodiment with the embodiment 1 are as follows:

Preparation of a lithium-ion battery cell: allowing the cathode tab 41 of the prepared electrode component 4 to be connected with a positive terminal 61 on a cap plate 6 by ultrasonic welding and the anode tab 42 to be connected with a negative terminal 62 on the cap plate 6 by ultrasonic welding, wherein the positive terminal 61 is electrically connected with a metal can 5, and an insulating disc is arranged between the negative terminal 62 and the metal can 5 to realize electrical insulation; arranging steel plates with the thickness of 0.2 mm on two larger surfaces of the electrode component 4 respectively; allowing the steel plates to be connected with the negative terminal 62 by ultrasonic welding; applying one layer of insulating film 8 on the surface of each steel plate, wherein the insulating film 8 has the thickness of 900 micrometers, is made of polypropylene (PP), and completely covers the steel plate; placing the electrode component 4 and the cap plate 6 into the metal can 5 (the metal can in the embodiment is an aluminum can) together with the steel plates; allowing the aluminum can to be connected with the cap plate 6 by laser welding; injecting the electrolyte into the aluminum can; and preparing the lithium-ion battery cell by the processes such as formation.

Others are the same with those of the embodiment 1 and not described in detail herein.

### Comparison Example 1

The differences of the comparison example with the embodiment 1 are as follows:

Preparation of a lithium-ion battery cell: allowing the anode tab of the prepared electrode component to be electrically connected with a positive terminal on a cap plate and the cathode tab to be electrically connected with a negative terminal, wherein the positive terminal and a metal can are subjected to electrical insulation, and the negative terminal and the metal can are subjected to electrical insulation; placing the electrode component and the cap plate into the metal can; allowing the metal can to be connected with the cap plate by laser welding; injecting the electrolyte into the metal can; preparing a lithium-ion battery cell by the processes such as reduction; injecting the electrolyte into the prepared lithium-ion battery cell; and preparing the lithium-ion battery cell of the comparison example by the processes such as formation.

The lithium-ion battery cells of the comparison example 1 and the embodiments 1 to 6 are subjected to nail penetration test. Firstly, the cells of the comparison example 1 and the embodiments 1 to 6 are fully charged. Specifically, the constant current charge is carried out first by adoption of 0.5 C current until the voltage is 4.2 V and then the constant voltage charge is carried out until the current is 0.05 C. Secondly, the cells are subjected to the nail penetration test, wherein nails with a diameter of 3 mm are penetrated into the lithium-ion battery cells of the comparison example 1 and the embodiments 1 to 6 respectively at the speed of 80 mm per second, the results as illustrated in table 1.

As illustrated in table 1, during the nail penetration test, the lithium-ion battery cells, provided with the safety components 7, of the embodiments 1 to 6 do not catch fire, and the temperature rise of the cells is also less than 100° C.; but the lithium-ion battery cell of the comparison example 1 burst into smoke and fire during the nail penetration test due to the absence of the safety components, and the maximum temperature rise is even more than 450° C. Obviously, the invention can greatly improve the safety performance of the lithium-ion battery cell as the lithium-ion battery cell provided by the invention is equipped with the safety components 7. When the cell is subjected to external severe damage, the safety components 7 and the metal can 5 are electrically connected with the two electrodes of the electrode component 4 respectively, the conversion of possible internal short circuit into external short circuit is realized, thus the current density inside the battery cell is reduced; a series of reactions caused by the overheating of a system in the cell are avoided; and the safety performance of the lithium-ion battery cell is guaranteed.

TABLE 1
Nail penetration Test Results of the Cells of the
Comparison Example 1 and the Embodiments 1 to 6

| | | Maximum Temperature Rise |
|---|---|---|
| | Nail penetration | of the Cells Subjected |
| Group | Test Phenomena | to Nail penetration Test |
| Comparison | Smoke, fire | >450° C. |
| Example 1 | | |
| Embodiment 1 | No smoke, no fire | <100° C. |
| Embodiment 2 | No smoke, no fire | <100° C. |
| Embodiment 3 | No smoke, no fire | <100° C. |
| Embodiment 4 | No smoke, no fire | <100° C. |
| Embodiment 5 | No smoke, no fire | <100° C. |
| Embodiment 6 | No smoke, no fire | <100° C. |

According to the above principles, appropriate changes and modifications can be made based on the embodiments of the invention. Therefore, the invention is not limited to the above disclosed and described embodiments, and the changes and the modifications to the invention should also be within the scope of protection of the claims of the invention. Moreover, despites of some terminologies used in the description, the terminologies are only for illustration and not intended to limit the invention.

What is claimed is:

1. A lithium-ion battery cell, comprising an electrode component, a metal can for accommodating the electrode component, an electrolyte injected into the metal can, and a cap plate combined to the metal can, wherein:
the electrode component comprises a cathode film, an anode film and separator between them;
a cathode tab is arranged on the cathode film;
an anode tab is arranged on the anode film;
the cap plate is provided with a positive terminal electrically connected with the cathode tab, a negative terminal is electrically connected with the anode tab, a liquid injection hole and an explosion-proof vent;
safety components is assembled between the metal can and the electrode component and electrically connected with the positive terminal or the negative terminal; and,
the metal can is electrically connected with the negative terminal or the positive terminal, respectively.

2. The lithium-ion battery cell according to claim 1, wherein the safety components are metal plates.

3. The lithium-ion battery cell according to claim 2, wherein the metal plates are aluminum plates, copper plates, steel plates or nickel plates.

4. The lithium-ion battery cell according to claim 2, wherein the thickness of the metal plates is between 0.005 mm and 2.0 mm.

5. The lithium-ion battery cell according to claim 4, wherein the thickness of the metal plates is between 0.1 mm and 0.3 mm.

6. The lithium-ion battery cell according to claim 1, wherein the length of the safety components is less than or equal to that of wide side faces of the electrode component and the width of the safety components is less than or equal to that of the wide side faces of the electrode component.

7. The lithium-ion battery cell according to claim 2, wherein an insulating film is arranged between each metal plate and the metal can.

8. The lithium-ion battery cell according to claim 7, wherein the insulating films are made of polypropylene (PP), polyethylene terephthalate (PET) or polyethylene (PE).

9. The lithium-ion battery cell according to claim 7, wherein the thickness of the insulating films is between 1 micrometer and 1000 micrometers.

10. The lithium-ion battery cell according to claim 1, wherein each safety component is provided with a tab which is electrically connected with the anode tab or the cathode tab.
